(19) United States
(12) Patent Application Publication
(10) Pub. No.: US 2008/0101835 A1
(43) Pub. Date: May 1, 2008

(54) Image reading apparatus

(75) Inventors: Mei-Yi Li, Miaoli (TW); Ya-Han Chuang, Hsinchu (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/976,875

(22) Filed: Oct. 29, 2007

(30) Foreign Application Priority Data
Oct. 30, 2006 (TW) 95140098

(51) Int. Cl. G03G 15/00

(52) U.S. Cl. 399/379

(57) ABSTRACT

An image reading apparatus, of which mounting plate is dust-proof, includes a casing, a mounting plate and a reading means. The mounting plate is disposed on the casing and composed of at least a nano-material. The reading means is disposed in the casing and located under the mounting plate.

This application claims the benefit of Taiwan application Serial No. 95140098, filed Oct. 30, 2006, the subject matter of which is incorporated herein by reference.

### BACKGROUND OF THE INVENTION

1. Field of the Invention

The invention relates in general to an image reading apparatus, and more particularly to an image reading apparatus of which the mounting plate is dust-proof.

2. Description of the Related Art

Nowadays, scanners play a very important role, for either personal or business use. When the content or image of a document is scanned by a scanner, the scanner stores the content or image of the document in a form of electronic files after the scan. Furthermore, the scanners can be categorized into flatbed scanners and sheet-fed scanners. In order to meet the various requirements of the users, at present, there exists also another type of scanner, which is a flatbed scanner assembled with an automatic document feeder (ADF). This type of scanner can be used as a flatbed scanner or a sheet-fed scanner.

Take the sheet-fed scanner as an example; the document to be scanned is fed into the ADF. When the document passes a scan window of the scanner, the optical module fixed under the scan window captures the images of the document and outputs the corresponding image signals. However, the scan window and the optical module are not manufactured as one unit, but just assembled together. Therefore, there normally exists some vacant space between the scan window and the optical module and dust particles in the air will easily enter the scanner through the vacant space and adhere to a lower surface of the scan window.

Conventionally, in order to clean the lower surface of the scan window, the scanner has to be taken apart, which is very inconvenient for the users. If the dust particles on the scan window are not cleaned out, in the scan operation, especially in a high-resolution scan operation, the optical module will scan the dust particles on the lower surface of the scan window along with the document. Such, the scan image generated will include the image of the dust.

### SUMMARY OF THE INVENTION

The invention is directed to an image reading apparatus. A mounting plate composed of at least a nano-material is disposed in the image reading apparatus. The nano-material is used for preventing the dust particles from adhering to the surface of the mounting plate to achieve a dust proof effect.

According to the present invention, an image reading apparatus is provided. The image reading apparatus includes a casing, a mounting plate and a reading means. The mounting plate is disposed on the casing and composed of at least a nano-material. The reading means is disposed in the casing and located under the mounting plate for reading an image of a document on the mounting plate.

The invention will become apparent from the following detailed description of the preferred but non-limiting embodiments. The following description is made with reference to the accompanying drawings.

### BRIEF DESCRIPTION OF THE DRAWINGS

FIG. 1 is an exploded view of an image reading apparatus according to a preferred embodiment of the invention.

FIG. 2A is a first cross-sectional view of the image reading apparatus of FIG. 1.

FIG. 2B is a second cross-sectional view of the image reading apparatus of FIG. 1.

FIG. 3 is a schematic diagram of the image reading apparatus of FIG. 1 having a cleaning unit and an air-blowing unit.

### DETAILED DESCRIPTION OF THE INVENTION

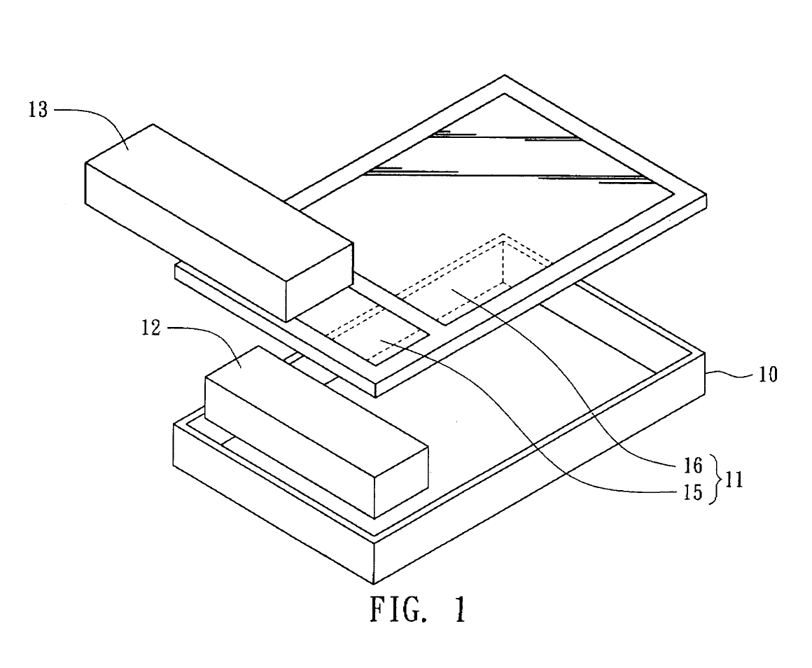

Referring to FIG. 1, an exploded view of an image reading apparatus according to a preferred embodiment of the invention is shown. As shown in FIG. 1, the image reading apparatus 1, of which mounting plate is dust-proof, comprises a casing 10, a mounting plate 11, a reading means 12 and an ADF 13. The mounting plate 11 is disposed on the casing 10 and composed of at least a nano-material. The reading means 12 is disposed in the casing 10 and located under the mounting plate 11 for reading an image of a document on the mounting plate 11.

The reading means 12 includes a charge-coupled device (CCD) or a contact image sensor (CIS). The reading means 12 can be fixed in the casing 12 or be disposed movably in the casing 10. In the embodiment, the reading means 12 is exemplified to be disposed movably in the casing 10.

The mounting plate 11 includes a first mounting plate 15 and a second mounting plate 16 of different sizes. When the user is to scan a stack of documents, he/she can put the documents on a paper tray of the ADF 13. When one of the documents is fed into a passage of the ADF 13 (not shown in the figure) and comes across the first mounting plate 15, the reading means 12 located under the first mounting plate 15 reads the image of the document. When the user is to scan one single document, he/she can put the document on the second mounting plate 16 and the reading means 12 located under the second mounting plate 16 will movably scan the document on the second mounting plate 16.

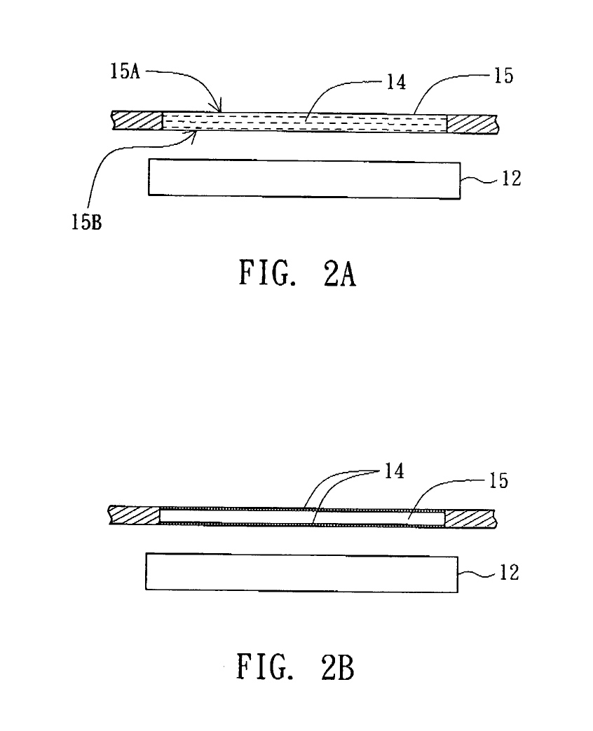

The first mounting plate 15 and the second mounting plate 16 can be made of glass or acrylic material. In the following description, the first mounting plate 15 is taken as an example for illustration. Referring to FIGS. 2A and 2B, a first cross-sectional view and a second cross-sectional view of the image reading apparatus of FIG. 1 are respectively shown. As shown in FIG. 2A, the first mounting plate 15 includes a glass substrate and a nano-material 14. The nano-material 14 is mixed with the glass substrate to form the first mounting plate 15. Therefore, the nano-material is distributed evenly on both the upper surface 15A and lower surface 15B of the first mounting plate 15. According to a specific physical feature of the nano-material 14, a particle larger than a nano scale (nanometer=10⁻⁹ meter) (normally larger than 10⁻⁴ mm) will contact the surface having the nano-material 14 at a large angle. Therefore, the dust particles will not adhere to the upper surface 15A or the lower surface 15B of the first mounting plate 15, which maintains cleanness of the upper and lower surfaces of the first mounting plate 15.

Besides, as shown in FIG. 2B, the first mounting plate 15 could be coated with a layer of the nano-material 14 to achieve the object of a dust-proof scan window. The upper and lower surfaces of the first mounting plate 15 are coated with nano-material 14 evenly. Preferably, the nano-material 14 forms nano molecular films. The nano molecular film has the same specific physical feature as the nano-material 14 and thus the upper and lower surfaces of the first mounting plate 15 can be kept clean. Due to structure design of the scanner, the dust particles on the upper surface of the first mounting plate 15 could be dusted more easily. Therefore, only the lower surface 15B of the first mounting plate 15 needs to be coated with the nano-material 14 to prevent the dust particles from adhering to the lower surface 15B of the first mounting plate 15.

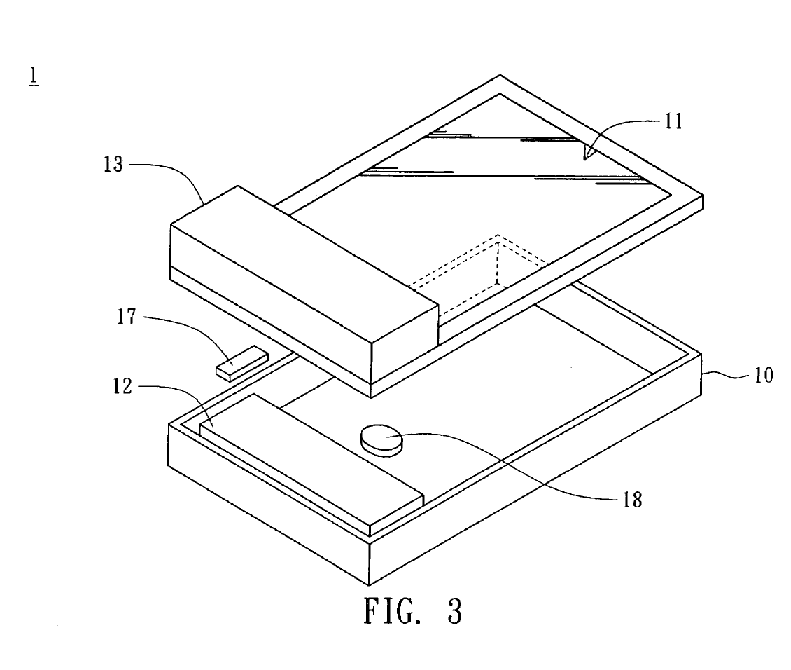

Although the nano-material 14 has the characteristics of repelling the dust particles larger than a nano scale, some of the dust particles may still adhere to the first mounting plate 15 or the second mounting plate 16. In this case, auxiliary devices can be used to assist cleaning the mounting plate. Referring to FIG. 3, a schematic diagram of the image reading apparatus of FIG. 1 having a cleaning unit and an air-blowing unit is shown. As shown in FIG. 3, the image reading apparatus 1 further includes a cleaning unit 17. The cleaning unit 17 is disposed in the casing 10 and, preferably, located above the reading means 12 and between the lower surface of the mounting plate 11 and the reading means 12. Even though the lower surface of the mounting plate 11 cannot repel all the dust particles to prevent their attachment, with the assistance of the cleaning unit 17, the dust particles can be easily cleaned out from the lower surface of the mounting plate 11. The cleaning unit 17 can spray cleaning liquid (such as water) on the lower surface of the mounting plate 11. When the cleaning liquid flows over the lower surface of the mounting plate 11, it can easily take away the dust particles. Moreover, the cleaning unit 17 can also be a scraper, a comb or an electrostatic brush for cleaning the dust particles on the lower surface of the mounting plate 11. Besides, the image reading apparatus 1 can further include an air-blowing unit 18. Similarly, the air-blowing unit is, preferably, disposed above the reading means 12 and between the lower surface of the mounting plate 11 and the reading means 12 for conveying air to the lower surface of the mounting plate 11 and drying it out.

The invention is not limited to being applied to the mounting plate 11 of that type of image reading apparatus 1 in FIG. 1. When the image reading apparatus 1 is a flatbed scanner or a sheet-fed scanner, the invention can also be applied to the mounting plate of the flatbed scanner or the sheet-fed scanner. When the image reading apparatus 1 is a flatbed scanner with an ADF, the invention can also be applied to the mounting plate of this type of image reading apparatus. Furthermore, the reading means 12 located under the mounting plate 11 can be movable or fixed. For example, when the image reading apparatus is a flatbed scanner, the reading means can be disposed movably under the lower surface of the mounting plate (the second mounting plate 16 of FIG. 1), while when the image reading apparatus is a sheet-fed scanner, the reading means is fixed under the lower surface of the mounting plate.

The image reading apparatus disclosed by the above embodiment of the invention uses a mounting plate composed of at least a nano-material to prevent the dust particles from adhering to the lower surface or upper surface of the mounting plate. In this way, the labor for cleaning the mounting plate can be saved and the quality of the images generated by the reading means will not be affected by the dust particles.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image reading apparatus, comprising:
a casing;
a mounting plate, disposed on the casing, wherein the mounting plate is composed of at least a nano-material; and
a reading means, disposed in the casing and located under the mounting plate, for reading an image of a document on the mounting plate.

2. The image reading apparatus according to claim 1, wherein the mounting plate has an upper surface and a lower surface, the lower surface is facing the reading means, and the lower surface of the mounting plate is coated with the nano-material.

3. The image reading apparatus according to claim 2, wherein the upper surface of the mounting plate is coated with the nano-material.

4. The image reading apparatus according to claim 1, wherein the mounting plate is made of glass.

5. The image reading apparatus according to claim 1, wherein the mounting plate is made of acrylic material.

6. The image reading apparatus according to claim 1, wherein the mounting plate comprises at least a glass substrate, which is mixed with the nano-material.

7. The image reading apparatus according to claim 1, wherein the reading means is movably disposed under the mounting plate.

8. The image reading apparatus according to claim 1, further comprising:
a cleaning unit, disposed in the casing for cleaning the mounting plate.

9. The image reading apparatus according to claim 8, wherein the cleaning unit is disposed between the reading means and the mounting plate.

10. The image reading apparatus according to claim 1, further comprising:
an air-blowing unit, disposed in the casing for drying the mounting plate.

11. The image reading apparatus according to claim 10, wherein the air-blowing unit is disposed between the reading means and the mounting plate.

12. The image reading apparatus according to claim 1, wherein the image reading apparatus is a flatbed scanner.

13. The image reading apparatus according to claim 1, wherein the image reading apparatus is a sheet-fed scanner.

14. The image reading apparatus according to claim 1, wherein the image reading apparatus is a flatbed scanner with an automatic document feeder (ADF).

15. The image reading apparatus according to claim 1, wherein the reading means comprises a charge-coupled device (CCD).

16. The image reading apparatus according to claim 1, wherein the reading means comprises a contact image sensor (CIS).
